(19) United States
(12) Patent Application Publication
(10) Pub. No.: US 2024/0366976 A1
(43) Pub. Date: Nov. 7, 2024

(54) TEXTILE CONNECTOR, ROPING HARNESS COMPRISING ONE SUCH TEXTILE CONNECTOR AND METHOD FOR MANUFACTURING SAME

(71) Applicant: ZEDEL, Crolles (FR)

(72) Inventor: Loïc Blondeau, La Tronche (FR)

(73) Assignee: ZEDEL, Crolles (FR)

(21) Appl. No.: 18/641,947

(22) Filed: Apr. 22, 2024

(30) Foreign Application Priority Data
May 4, 2023 (FR) 2304491

(51) Int. Cl. A62B 35/00; D03D 1/00; D03D 3/02; D03D 15/573; D04B 1/22; D04B 21/20; D04C 1/12

(52) U.S. Cl. CPC A62B 35/0025; A62B 35/0006; A62B 35/0018; D03D 1/00; D03D 3/02; D03D 15/573; D04B 1/225; D04B 21/205; D04C 1/12; D10B 2505/00

(57) ABSTRACT

A textile connector comprises a woven element in the shape of a tubular ring and a yarn forming a plurality of loops arranged in the tubular ring. The loops provide a strength of the textile connector. A seam is formed by means of at least one yarn passing through the two ends of the woven element several times to close the tubular ring. The woven element is a tubular woven element defining a through hole from a first end to an opposite second end along a longitudinal axis. The first end is an outer end that overlaps the second end forming an inner end. The seam secures the outer end with the inner end and defines joins angularly offset from one another when observed in the longitudinal direction.

### BACKGROUND OF THE INVENTION

The invention relates to a textile connector, to a roping harness and to a method for manufacturing one such textile connector.

### PRIOR ART

In the field of working at heights, it is known to form textile connectors that come in the form of a ring. In a particular embodiment, two ends of a webbing are fixed on one another to define a closed ring able to withstand a considerable strain, for example a fall.

A textile connector is commonly used in climbing harnesses to join the leg loops to the belt. A method for manufacturing the connector is disclosed in the document FR2857879 and also in the document US2008/229558. The document US2008/229558 discloses a tubular textile, in particular a braid, that is folded onto itself several times or that is wound to form the ring.

It is also known from the document EP3069764 to form an annular connector having a sheath formed by a webbing. A yarn is wound so as to define several circles superposed on one another. A webbing is installed to wrap all of the circles and define a webbing ring. A linear seam is made extending in the longitudinal direction of the webbing so as to shape the webbing into a tubular ring, i.e. in the form of a tubular sheath the strands of which are shaped into a circle to form the core of the connector. It is apparent from the foregoing that this manufacturing method is difficult to implement. It is also apparent that the two thicknesses of webbing secured to one another form a stiff portion that may complicate use of the connector. The linear seam generally extends over the whole of the inner surface of the ring.

The document US2020/0108294 discloses a filament that is wound so as to form several circles. The circles are arranged around an annular textile that is then folded around the circles to enclose the circles of filament inside a sheath formed by the tubular textile. A seam is formed on the circumference of the sheath.

### OBJECT OF THE INVENTION

One object of the invention consists in providing a connector that presents a better homogeneity of the sheath.

This result tends to be achieved by means of a textile connector comprising:
a yarn element forming a plurality of loops, the loops providing a mechanical strength of the textile connector;
a textile element shaped as a tubular ring to form a sheath around the plurality of loops;
and
a seam formed by means of at least one yarn passing through the textile element several times to close the tubular ring.

The textile connector is remarkable in that the textile element is a tubular textile element defining a through hole passing from a first end to an opposite second end in a longitudinal direction;
in that the seam secures the first end with the second end and defines joins angularly offset from one another in an observation along the longitudinal axis.

In advantageous manner, the yarn has a first end and a second end that are not secured to one another, the yarn defining at least four loops.

In a particular configuration, the yarn has a first end and a second end that are secured to one another by a knot.

In an advantageous development, the loops represent an occupancy ratio of the inside of the tubular ring of at least 50%.

Preferentially, the joins secure the outer face of the first end and the outer face of the second end straddling at least one of the first end and the second end to form a slideway in the longitudinal direction.

Preferentially, the first end is an outer end that covers the second end forming an inner end, the outer end covering the inner end to define an overlap area. The joins extend from the overlap area of the outer end up to the inner end outside the overlap area in the longitudinal direction.

According to one embodiment, two consecutive joins are offset in the longitudinal direction.

In preferential manner, the joins are contained in a plane that is perpendicular to the longitudinal axis.

Advantageously, the successive joins extend over an angular sector at least equal to 180°. Even more advantageously, the successive joins extend over an angular sector at least equal to 360°.

In a preferential development, the seam is a radial seam with joins that pass through a central section of the tubular woven element, the central section corresponding to a circular section representing less than 50% of the section of the tubular textile element.

It is a further object of the invention to provide a roping harness having a joining link between the belt and the leg loops that is more efficient than the connections of the prior art.

This result tends to be achieved by means of a roping harness comprising a belt, a pair of leg loops and a textile connector according to any one of the foregoing configurations, the textile connector joining the belt and the pair of leg loops.

It is a further object of the invention to provide a method for manufacturing a textile connector that is easy to implement and that enables a textile connector to be formed that is more efficient than those of the prior art.

This result tends to be achieved by means of a method for manufacturing a textile connector comprising the following steps:
providing a tubular textile element defining a through hole and a yarn;
winding the yarn to form a plurality of loops, each loop passing through the through hole;
stretching the textile element to join the two ends of the textile element and form a tubular ring around the loops;
securing the two ends of the textile element by a seam formed by means of at least one yarn passing through the two longitudinal ends of the textile element several times to close the tubular ring, the seam defining joins angularly offset from one another when observed in the longitudinal direction.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 is a schematic view of a first step of manufacture of a textile connector;

FIG. 2 is a schematic view of a second step of manufacture of a textile connector;

FIG. 3 is a schematic view of a second step of manufacture of a textile connector according to another embodiment;

FIG. 4 is a schematic view of a third step of manufacture of a textile connector;

FIG. 5 is a schematic cross-sectional view of closing of a textile connector according to a particular embodiment of a pass-through radial seam;

FIG. 6 is a schematic side view of closing of a textile connector with a spiral seam;

FIG. 7 is a schematic side view of closing of a textile connector according to another embodiment with a radial seam;

FIG. 8 is a schematic cross-sectional view of closing of a textile connector in a cutting plane perpendicular to the longitudinal axis with a partial radial seam;

FIG. 9 is a schematic cross-sectional view of closing of a textile connector in a cutting plane perpendicular to the longitudinal axis with a pass-through radial seam;

FIG. 10 is a schematic elevational view of a textile connector according to the embodiment illustrated in FIGS. 7 to 9;

FIG. 11 is an elevational view of a roping harness comprising a textile connector;

FIG. 12 is a cross-sectional view of a textile connector without a yarn and filling element;

FIG. 13 is a cross-sectional view of a textile connector provided with a filling element;

FIG. 14 is an elevational view of a roping harness comprising other textile connectors.

### DESCRIPTION OF THE EMBODIMENTS

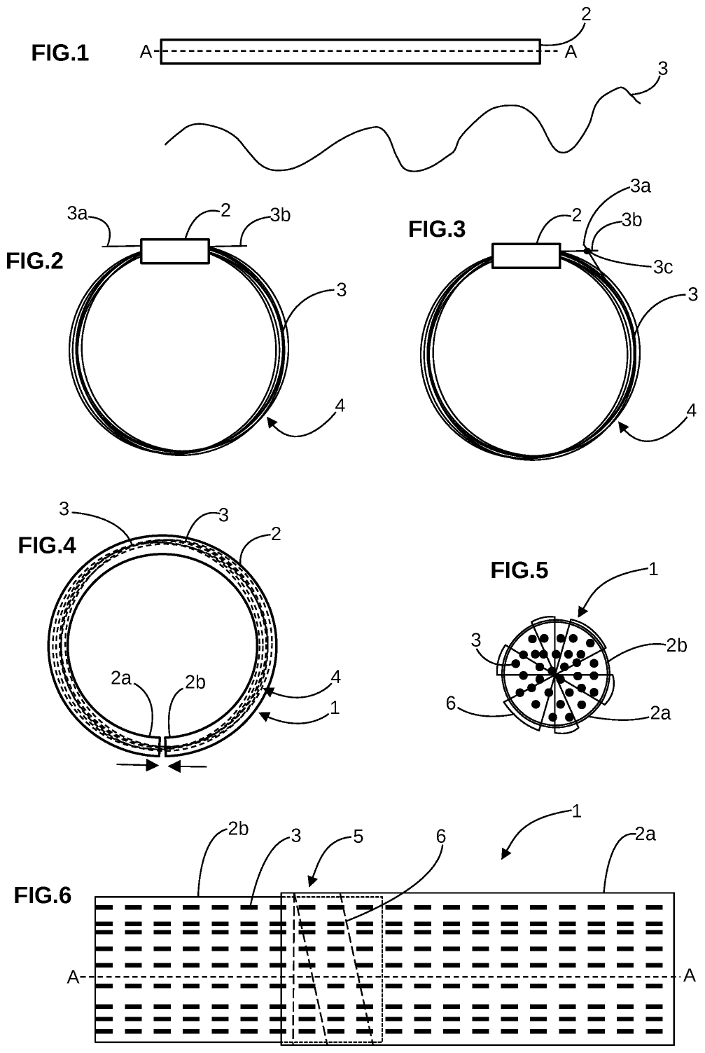

FIGS. 1 to 14 illustrate a textile connector 1 and the steps of its manufacturing method or its integration in a roping harness. The textile connector 1 is formed by means of a textile element 2 of tubular shape and a yarn 3. The yarn 3 is a thread of any cross-section, for example circular, rectangular or square. The yarn 3 is a resistance wire that provides the strength to withstand a tensile stress of the textile connector 1. The textile element can be a woven element, a knitted element or a braided element of tubular shape. Preferentially, the textile element is formed in a single weaving, knitting or braiding operation, i.e. without transferring the textile element onto another piece of equipment.

The yarn 3 is able to be wound to form a plurality of loops 4, i.e. a plurality of circles. The loops 4 are arranged behind one another in the longitudinal direction of the yarn 3. The loops 4 are arranged on one another so as to form a general annular shape.

The textile element 2 extends along a longitudinal axis A and defines a through hole in the longitudinal direction. When multiple loops 4 are formed, the yarn 3 passes through the through hole. For example, one end of the yarn 3 is associated with a needle and the needle passes several times through the through hole to form the loops 4. To make it easier for the yarn 3 to pass, it is advantageous to shorten tubular webbing 2, i.e. by reducing the length of tubular webbing 2 in the longitudinal direction A, i.e. perpendicularly to the cutting plane that defines the through hole. The two ends of the textile element 2 are designed to join up to form a sheath around the loops. The two ends join up to define a ring.

The minimum number of loops 4 depends on the performances required for the textile connector 1, for loops made from a predefined material.

The multiple loops 4 can be made in different ways. In an advantageous embodiment illustrated in FIG. 2, the multiple loops 4 are formed and the two ends of the two strands 3a and 3b of the yarn 3 are not fixed to one another. The two ends are free to move with respect to one another. The loops 4 are kept in place by the friction forces that exist between the multiple portions of the yarns that form the loops 4. The more the number of loops is increased, the more the contact surfaces between the loops are increased, which has the effect of increasing the friction forces. Even in the absence of knots at the ends of the yarn, the loops are able to keep their dimensions when they are subjected to a force that tends to open the loops 4.

The number of loops to be formed to ensure that the loops are preserved depends on the occupancy ratio of the yarns in the through hole of the tubular webbing and on the surface state of the yarn. The rougher the yarn, the higher the friction forces will be, which enables the number of turns 4 to be reduced. To reduce the number of loops, it is advantageous to have a yarn the surface roughness of which increases in order to have the highest possible static friction force. The surface is rough and preferentially devoid of annular peaks or annular grooves.

To reduce the number of loops, it is advantageous to limit the possibilities of movement of the loops with respect to one another inside the sheath. It is also advantageous to have an occupancy ratio of the through hole by the yarn of at least 50%, preferentially at least 60% and even more preferentially at least 70% or even at least 80% or 90% per volume. By judiciously choosing the inner cross-section of the sheath, the cross-section of the yarn and the surface roughness of the yarn, it is possible to prevent opening of the loops upwards of four loops. When the latter are subjected to a load force, it is the friction between the loops and not the strength of the sheath that ensures securing. It is advantageous to form at least 10 loops, preferentially at least 15 loops, or even at least 20 loops or at least 30 loops.

In an alternative embodiment, the multiple loops 4 are formed and the two ends of the two strands 3a and 3b of the yarn 3 are secured to one another. It is advantageous for securing to be performed by a knot 3c formed by first end 3a with second end 3b. As the two ends are fixed, it is possible to use a smaller number of loops 4, preferably less than ten loops 4. This embodiment makes it possible to release the constraints on the surface roughness of the yarn and on the occupancy ratio of the sheath by the yarn loops.

Once the loops 4 have been formed, the textile element 2 is stretched so that the two opposite ends in the longitudinal direction A are in contact with one another. The textile element 2 defines a first end and a second end that are opposite one another in the longitudinal direction A. The textile element 2 follows the yarn 3 and reproduces the shape of the loops 4. The textile element 2 forms a tubular ring. The textile element 2 forms a tube that limits the movements of the loops 4 with respect to one another. In preferential manner, the textile element 2 defines a first end called outer end 2a that is arranged around a second end called inner end 2b as illustrated in FIG. 4. Outer end 2a overlaps on inner end 2b and defines an overlap area that is of annular shape. In an alternative embodiment, the two ends are placed facing one another in the longitudinal direction A, and it is possible to add an annular reinforcement that covers the two ends and that is passed through by the multiple loops 4. The annular reinforcement can be a textile element, made from polymer material or from any suitable material facilitating securing of the two ends.

The loops 4 are limited in movement with respect to one another by means of tubular webbing 2. Tubular webbing 2 is preferentially made from a material that has a lower strength than the strength of the set of the loops 4 for forces that tend to increase the diameter of the loops 4. In other words, the strength of the textile connector 1 that opposes a tensile load along a diameter is not procured by tubular webbing 2 but by the multiple loops 4. In the absence of the loops 4, tubular webbing 2 tears whereas the textile connector 1 provided with the loops 4 withstands the stress, the other characteristics being identical.

The first end and second end of tubular webbing 2 are secured to one another by a seam 5. The seam 5 is formed by means of at least one seam yarn 6 that passes through tubular webbing 2 several times. The seam defines a plurality of joins by means of the at least one seam yarn 6 assembling the first tubular end fixedly with the second tubular end to close the tubular ring around the loops 4. The joins are angularly offset from one another when observed in the longitudinal direction A. The joins are arranged revolving around the longitudinal axis A passing through the centre or almost through the centre of the cross-section of the tube. FIGS. 5, 6, 7, 8, 9 and 10 illustrate different embodiments of the joins that link the two ends fixedly in the longitudinal direction A.

In preferential manner, the seam 5 is a radial seam with joins that pass through a central section of tubular webbing 2. The central section corresponds to a circular section representing less than 50% of the section of the tube. Such an embodiment is illustrated in FIG. 5. This embodiment enables the movements of the yarn loops 4 to be limited.

The strands of the at least one seam yarn pass exactly or approximately through tubular webbing 2 to form a diameter which limits the movements of the yarn 3 forming the loops 4 in the tube. The extra thickness of webbing 2 originating from the overlap area is limited to a ring of small dimension in the longitudinal direction A thereby enabling a better behaviour of the textile connector 1 to be had when the latter is deformed. It is also apparent that the radial seam is made over a shorter length which makes this operation more advantageous to perform.

In an embodiment illustrated in FIG. 6, a first set of joins is contained in a plane that is perpendicular to the longitudinal axis A. In other words, the joins define a purely radial seam. The joins form diameters or substantially diameters that are included in one and the same plane. The joins pass solely through the overlap area in order to secure the two layers of the textile element 2. Between two joins, the seam yarn 6 extends exclusively perpendicularly to the longitudinal axis A.

In another embodiment also illustrated in FIG. 6, a second set of joins presents itself in the form of a spiral seam. Two consecutive joins are offset in the longitudinal direction A. Between two joins, yarn 5 extends mainly perpendicularly to the longitudinal axis A. The portion of the seam yarn 6 that runs along the outer wall of tubular webbing 2 extends in the longitudinal direction A and along an angular sector of the circle perpendicular to the longitudinal axis A such as the one illustrated in FIG. 5. FIG. 6 illustrates an overlap between the two ends of the textile element 2 with the loops 4 represented in dashed lines and joins that form a full turn in radial configuration and two full turns in spiral configuration.

In preferential manner, the multiple joins connect the outer wall of the first end with the outer wall of the second end straddling the interface between the two ends in the longitudinal direction A to close the ring. This configuration makes it possible to define an annular slideway around the longitudinal direction A. A connector that slides against the outer wall of the sheath comes into contact with the joins and slides on the termination or terminations of the sheath. This embodiment is advantageous when the two ends of the textile element 2 are arranged facing one another in the longitudinal direction A, preferentially in contact.

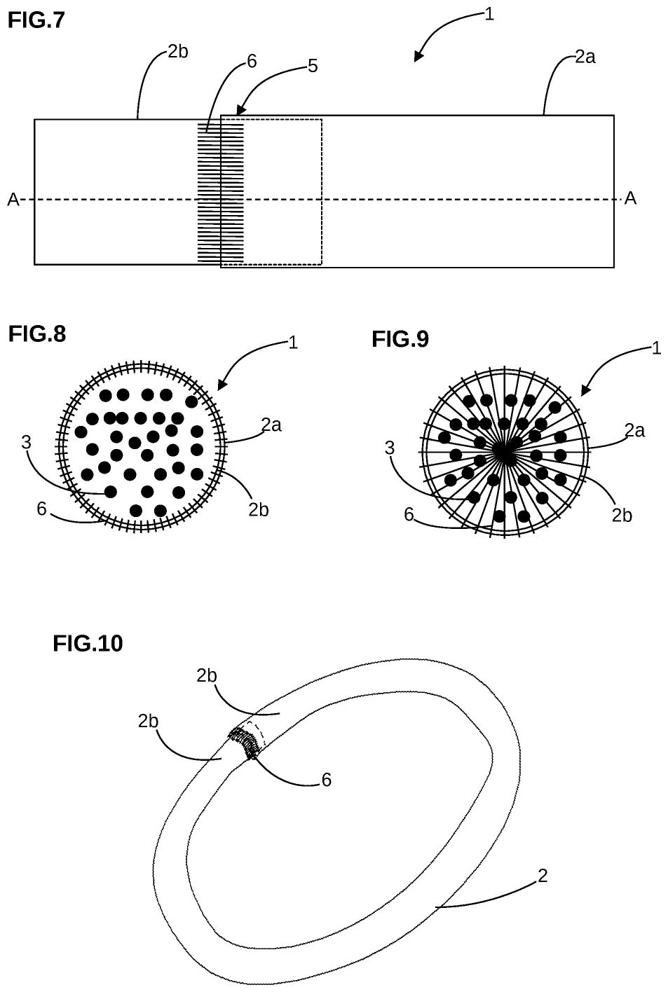

It is however particularly advantageous for there to be an overlap and for the seam yarn 6 to run along the outer wall of tubular webbing 2 from outer end 2a to inner end 2b. The seam yarn 6 is depressed into tubular webbing 2 in the overlap area to secure outer end 2a with inner end 2b and it is also depressed into inner end 2b outside the overlap area. The seam yarn 6 forms a slideway above the terminal portion of outer end 2a so as to press the terminal portion of outer end 2a against inner end 2b or at least to prevent the terminal portion of the inner end from rising up when an element slides against tubular webbing 2. An embodiment is illustrated in FIG. 7 with portions of seam yarn that extend exclusively in the longitudinal direction A, but a misalignment of the seams with respect to the axis A is possible so long as the seam connects the outer end in the overlap area with the inner end outside the overlap area. The adjacent joins are offset angularly and form an annular slideway that caps the terminal part of the outer end so that sliding of an element along the textile connector in the longitudinal direction A does not catch against the terminal part. The overlap enables an extra thickness to be formed that stiffens the ring slightly and facilitates the formation of joins. FIG. 7 illustrates joins that press the terminal part of the outer end against the inner end forming slideways. In the illustrated embodiment, the joins are parallel to the longitudinal direction A in their outer part and it is possible to offset them angularly. The embodiment illustrated in FIG. 7 can be achieved with a surface seam as indicated in FIG. 8 or with a radial seam as illustrated in FIG. 9.

To have an efficient seam between the two ends of tubular webbing 2, the successive joins extend over an angular sector at least equal to 180°. The angle is measured with an observation in the longitudinal direction 1. In even more preferential manner, the successive joins extend over an angular sector at least equal to 360°. An angle of 360° corresponds to a full coverage of the circumference and a coverage of more than 360° corresponds to two seams that overlap in an observation in the longitudinal direction A.

The textile element 2 of tubular shape can present any weaving pattern and can be a braid or a knitted fabric.

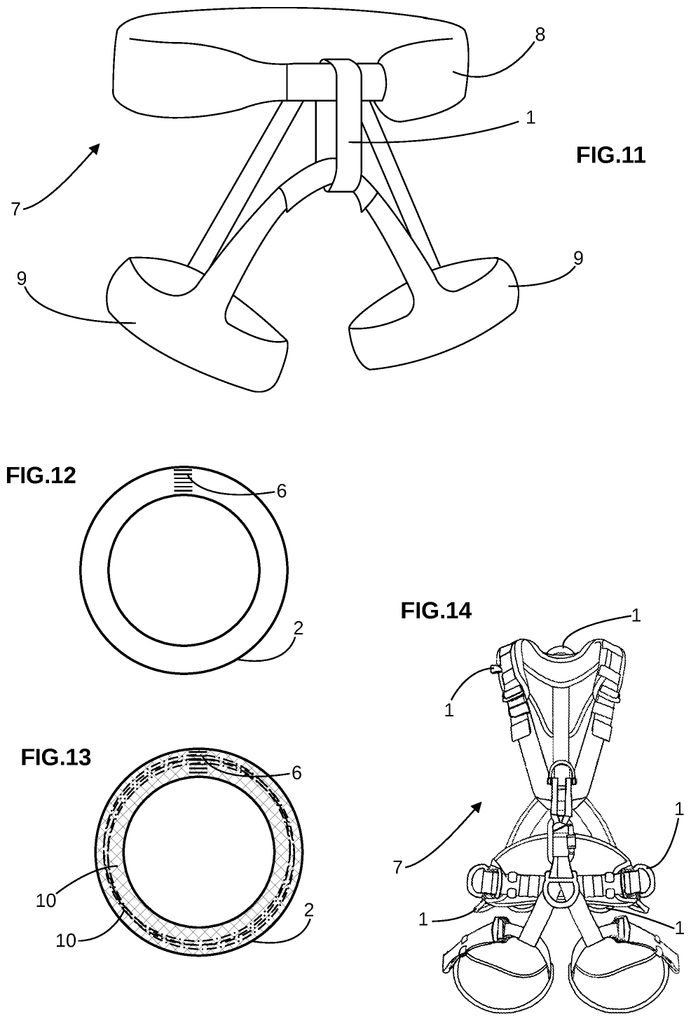

In preferential manner, the multiple loops 4 occupy more than 30% of the inner volume defined by the textile element 2, preferentially more than 50% and even more preferentially more than 70% or even more than 80%. Advantageously, the multiple loops 4 occupy less than 90% of the inner volume defined by the tubular webbing. FIG. 11 illustrates a roping harness 7 that comprises a belt 8 and a pair of leg loops 9. The belt 8 is connected to the leg loops 9 by the textile connector 1. The textile connector 1 is able to form a ventral suspension point, i.e. it is able to suspend the user wearing the harness. However, the textile connector 1 can be used to form another part of a roping harness 7, for example a sternal attachment point, or an attachment point on a shoulder strap. It is also possible to attach the textile connector 1 to a lanyard.

In more general manner, it is advantageous to form a ring made from textile material having a trade-off between weight, mechanical performances and cost that is better mastered. When the required mechanical performances are primordial, it is advantageous to fill the tube with several yarn loops. For lesser mechanical performances on the other hand, the ring can be devoid of yarn loops. The strength is provided by the mechanical characteristics of the textile tube. FIG. 12 illustrates a textile connector 1 devoid of yarn loops 3.

Depending on the configuration of the textile connector 1, the latter can be used as a ventral attachment ring of a roping harness, for example a mountaineering harness. The textile connector 1 can be used as closing ring of a roping harness for formation of a sternal attachment point, for example for a sternal ring of a harness marketed under the tradename NEWTON or VOLT. It is further possible to use the textile connector as a gear sling of a roping harness, of a rucksack, of an equipment holder and more generally of a bag. The textile connector 1 can be fixed to another connector, preferentially a metal connector, for example a snap-hook. The textile connector 1 can be used as a handle to support a stretcher. FIG. 14 illustrates a roping harness 7 provided with a dorsal suspension point, a lateral suspension point or a ventral suspension point formed by a textile connector 1. The roping harness 7 is equipped with gear slings arranged on the belt or on a shoulder strap.

The textile connector 1 has a textile tube formed in a single piece, i.e. an intrinsically annular part, for example a tubular webbing or a braid, the two ends of which are joined to one another and secured by a radial seam. The tube is closed by means of a single seam that is annular thereby enabling a more homogeneous thickness to be had over the whole circumference of the tubular ring.

When the ring is not provided with yarn loops inside the tube, it is advantageous to fill the tube with a filling element 10 to prevent the ring from flattening. FIG. 13 illustrates a textile connector that is filled with different filling elements 10. The filling element 10 has a tensile strength that is lower than the tensile strength of the tubular ring on its own. The mechanical effect of the filling element 10 on the performances of the textile connector is low or even nil compared with that provided by the textile ring only. For example, the inside of the tube is filled with a foam, a gel or a paste. The filling element 10 can be a filling filament, for example a thread, a rope, a cord or a webbing. It may be advantageous to use a filling filament to increase the friction between the yarns that form the loops even if the filling yarn presents less good mechanical performances, for example a lower tensile strength.

It is preferable for the material placed inside the tube to be passed through by the seam yarn. Filling material 10 has an elongation at break that is lower than the elongation at break of the tube. The mechanical performances are provided by the tube and not by filling material 10 that only acts to define the shape of textile connector 1.

1. Annular textile connector comprising:
a tubular textile element having a first end and an opposite second end along a longitudinal axis, the first end joining the second end to shape the tubular textile element as a tubular ring, the tubular textile element being a tubular webbing, a tubular knitted fabric or a tubular braid;
a seam formed by means of joins of at least one seam yarn that passes through the tubular textile element several times to close the tubular ring;
wherein an inside of the tubular textile element is filled by
a) a loop yarn forming a plurality of loops, the tubular textile element being made from a material that has a lower strength than a strength of the plurality of loops for forces that tend to increase the diameter of the loops; and/or
b) a filling element having a lower tensile strength than a tensile strength of the tubular ring;
wherein the tubular textile element in the form of a tubular ring forms a sheath around the plurality of loops and/or the filling element; and
wherein the seam is a radial seam with joins that pass through a central section of the tubular textile element, the central section corresponding to a circular section representing less than 50% of the section of the tubular textile element, the seam defining joins angularly offset from one another when observed in the longitudinal direction.

2. Annular textile connector according to claim 1 wherein the joins secure an outer face of the first end and an inner face of the second end and form a slideway in the longitudinal direction between the outer face of the first end and an outer face of the second end.

3. Annular textile connector according to claim 2 wherein the first end is an outer end that overlaps the second end forming an inner end, the outer end overlapping the inner end to define an overlap area and wherein the joins extend from the overlap area of the outer end up to the inner end outside the overlap area in the longitudinal direction.

4. Annular textile connector according to claim 1 wherein two consecutive joins are offset in the longitudinal direction.

5. Annular textile connector according to claim 1 wherein the joins are contained in a plane that is perpendicular to the longitudinal axis.

6. Annular textile connector according to claim 1 wherein the successive joins extend over an annular sector at least equal to 180°.

7. Annular textile connector according to claim 6 wherein the successive joins extend over an annular sector at least equal to 360°.

8. Annular textile connector according to claim 1 wherein the loop yarn has a first end and a second end that are not secured to one another, the loop yarn defining at least four loops.

9. Annular textile connector according to claim 1 wherein the loop yarn has a first end and a second end that are secured to one another by a knot.

10. Annular textile connector according to claim 1 wherein the loops represent an occupancy ratio of the inside of the tubular ring of at least 50%.

11. Annular textile connector according to claim 1 wherein the filling element is chosen from a foam, a gel, a paste and a filling yarn different from the loop yarn.

12. Roping harness comprising a belt, a pair of leg loops and an annular textile connector according to claim 1, the annular textile connector connecting the belt and the pair of leg loops or forming a dorsal or sternal suspension point.

13. Method for manufacturing an annular textile connector comprising the following steps:
providing a tubular textile element defining a through hole, the tubular textile element being chosen from a tubular webbing, a tubular knitted fabric or a tubular braid;
shaping the tubular textile element to join the two longitudinal ends of the tubular textile element and form a tubular ring;
securing the two ends of the tubular textile element by a seam formed by means of at least one seam yarn passing through the two longitudinal ends of the textile element several times to close the tubular ring, the seam defining joins angularly offset from one another when observed in the longitudinal direction;
wherein before securing the two ends of the tubular textile element by the seam, the tubular textile element is filled by
a) a loop yarn forming a plurality of loops, the tubular textile element being made from a material that has a lower strength than a strength of the plurality of loops for forces that tend to increase the diameter of the loops; and/or
b) a filling element having a lower tensile strength than a tensile strength of the tubular ring;
wherein the tubular textile element in the form of a tubular ring forms a sheath around the plurality of loops and/or the filling element; and
wherein the seam is a radial seam with joins that pass through a central section of the tubular textile element, the central section corresponding to a circular section representing less than 50% of the section of the tubular textile element.

14. Method for manufacturing according to claim 13 further comprising winding of a filament to form a plurality of loops, each loop passing through the through hole of the tubular textile element; and
wherein the tubular textile element is in the form of a tubular ring around the loops.
